(19) United States
(12) Patent Application Publication
(10) Pub. No.: US 2024/0351296 A1
(43) Pub. Date: Oct. 24, 2024

(54) Method of Carving Hollow Core Materials

(71) Applicant: Peter Sing, McCleary, WA (US)

(72) Inventor: Peter Sing, McCleary, WA (US)

(21) Appl. No.: 18/136,740

(22) Filed: Apr. 19, 2023

(51) Int. Cl. B29C 69/00

(52) U.S. Cl. CPC B29C 69/001; B29C 2793/0054

(57) ABSTRACT

The premise of this invention is to improve the methods for allowing one to carve the surface of a hollow core panel or other hollow core materials, such as but not limited to Sing Core, U.S. Pat. No. 7,147,741. In the past, in order to achieve a shallow carving in the surface of the panel one would apply a thicker surface material, or skin material, greater than the depth of the desired carving. Skin materials can be any flat sheet building materials such as plywood, MDF, HPL, fiberglass, wood products, metals, or any other type of flat sheet building materials. Another previously used method is to implant solid lumber that is the same thickness of the core inside the panel. The skin materials can then be pressed over the core and lumber implants. That method works well, but the use of solid lumber creates a weak point across the panel and greatly increases the thermal bridging between each face of the panel.

This new method of carving hollow core materials begins as a hollow core panel before the skin materials are applied. The areas where the final carvings need to be can first be carved out of the core material. Core material can be any hollow core materials such as paper core, LVL core, foam core, honeycomb core such as Sing Core, or any other core materials. The groove or carved space in the core can then be filled with a solid piece or pieces of the same material as the skin material. The material filling the groove or carving in the core can be slightly thicker than the depth of the final carving depth. The material filling the groove can be coated in an adhesive of choice before placing the inlay material in the groove. Once the material is placed in the groove, skin material can be applied both faces of the panel with an adhesive of choice and placed under pressure until the adhesive is cured. Once the adhesive is fully cured, the panel can be trimmed and the desired final carvings can be routed or carved. For precise lines and fine details, a CNC machine would be the ideal tool for making perfect lines. With the inlay, or embedded material, matching the skin material, the finished panel will appear to be made of solid lumber, but will have the lightweight and increased strength of the hollow core material.

### BACKGROUND OF INVENTION

This new method of carving hollow core panels/materials can begin as a hollow core panel before the skin materials are applied. Hollow core can be any hollow core material such as paper core, foam core, fiberglass core, LVL core, or honeycomb core like Sing Core, U.S. Pat. No. 7,147,741. The areas where the final carvings need to be can first be carved out of the core material. Core material can be any hollow core materials such as paper core, LVL core, foam core, honeycomb core such as Sing Core, or any other core materials. The groove or carved space in the core can then be filled with a solid piece or pieces of the same material as the skin material. The material filling the groove or carving in the core can be slightly thicker than the depth of the final carving depth. The material filling the groove can be coated in an adhesive of choice before placing the inlay material in the groove. Once the material is placed in the groove, skin material can be applied both faces of the panel with an adhesive of choice and placed under pressure until the adhesive is cured. Once the adhesive is fully cured, the panel can be trimmed and the desired final carvings can be routed or carved. For precise lines and fine details, a CNC machine would be the ideal tool for making perfect lines. With the inlay, or embedded material, matching the skin material, the finished panel will appear to be made of solid lumber, but will have the lightweight and increased strength of the hollow core material.

The use of reinforced honeycomb core, such as Sing Core, U.S. Pat. No. 7,147,741, is an ideal substrate for this method of carving deigns in a hollow core panel. The vertical grain wood fibers from Sing Core's grids will provide great strength to the carving inlays while stabilized by the rigid foam. Sing Core's unique design will support the carving inlay and not allow any movement. Sing Core substrate will prevent any weak point around the carving and provide great dimensional stability.

Alternatively, a standard finished hollow core panel, with no implanted lumber for carving, can be carved in the desired design(s) which will expose the core material of the hollow core panel. A filler material can then be put into the groove(s), or carving(s), to cover the core material. The filler material can be the same material as the skin material or can be wood filler, epoxy, or any other desired filler material. The filler can match the skin or can be colored to create artistic designs. One could even layer multiple materials or colors, or in any combination, to achieve a desired design. Once the filler is in place, the surface could be sanded to achieve a perfectly flat surface. The panel can then be carved in the final design, following the previously made reinforced carvings. CNC machinery can make the carvings exact with no deviations.

Alternatively, additional layers of desired skin material, which can match the original skin material or be any combination of desired materials, can be applied to the surface of the panel. The surplus of material can then be carved to create a raised design.

### SUMMARY OF INVENTION

This new method of carving hollow core materials begins as a hollow core panel before the skin materials are applied. The areas where the final carvings need to be can first be carved out of the core material. Core material can be any hollow core materials such as paper core, LVL core, foam core, honeycomb core such as Sing Core, or any other core materials. The channel or carving in the core can then be filled with a solid piece or pieces of the same material as the skin material. The material filling the groove or carving in the core can be slightly thicker than the depth of the final carving depth. The material filling the channel can be coated in an adhesive of choice before placing the inlay material in the groove. Once the material is in the groove, skin material can be applied to the faces of the panel with any adhesive and placed under pressure until the adhesive is cured. Once the adhesive is fully cured, the panel can be trimmed and the desired final carvings can be routed or carved. For precise lines and fine details, a CNC machine would be the ideal tool for making perfect lines. With the inlay, or embedded material, matching the skin material, the finished panel will appear to be made of solid lumber, but will have the lightweight and increased strength of the hollow core material.

The use of reinforced honeycomb core, such as Sing Core, U.S. Pat. No. 7,147,741, is an ideal substrate for this method of carving deigns in a hollow core panel. The vertical grain wood fibers from Sing Core's grids will provide great strength to the carving inlays while stabilized by the rigid foam. Sing Core's unique design will support the carving inlay and not allow any movement. Sing Core substrate will prevent any weak point around the carving and provide great dimensional stability.

Alternatively, a standard finished hollow core panel, with no implanted lumber for carving, can be carved in the desired design(s) which will expose the core material of the hollow core panel. A filler material can then be put into the groove(s), or carving(s), to cover the core material. The filler material can be the same material as the skin material or can be wood filler, epoxy, or any other desired filler material. The filler can match the skin or can be colored to create artistic designs. One could even layer multiple materials or colors, or in any combination, to achieve a desired design. Once the filler is in place, the surface could be sanded to achieve a perfectly flat surface. The panel can then be carved in the final design, following the previously made reinforced carvings. CNC machinery can make the carvings exact with no deviations.

Alternatively, additional layers of desired skin material, which can match the original skin material or be any combination of desired materials, can be applied to the surface of the panel. The surplus of material can then be carved to create a raised design.

### SHORT FIGURE DESCRIPTION OF DRAWINGS

FIG. 1 is a front view of hollow core to be used in hollow core building materials.

FIG. 2 is a front view of hollow core with the initial carving.

FIG. 3 is a front view of hollow core with the initial carving filled.

FIG. 4 is a front view of hollow core with the skin material applied to both surfaces.

FIG. 5 is a front view of the hollow core panel with the final carving in the face.

FIG. 6 is a front view of a basic hollow core panel with the initial carving through the face into the hollow core material.

FIG. 7 is a front view of the hollow core panel with the initial carving filled.

FIG. 8 is a front view of the hollow core panel with the final carving in the face.

FIG. 9 is a side view of the hollow core panel.

FIG. 10 is a side view of the hollow core panel with the initial carving into the core material.

### DESCRIPTION OF THE PREFERRED EMBODIMENTS

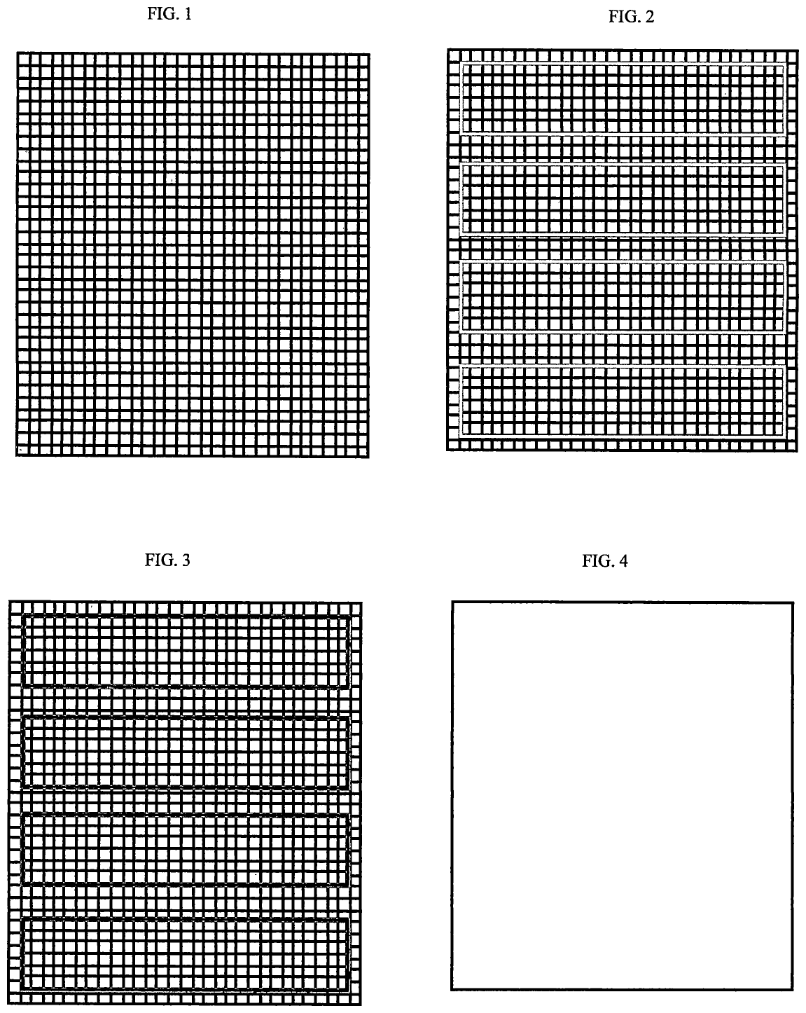

This method of carving hollow core materials begins as hollow core FIG. 1 to be used in hollow core building materials. The core can then be carved in the desired design(s) FIG. 2. The initial carvings can be filled with a filler material of choice FIG. 3. The filler material can be wood, metal, fiberglass, epoxy, wood filler, or any other filler material. Skin material can then be adhered to the panel FIG. 4. Skin material can be any flat sheet building material such as plywood, MDF, sheet metals, FRP, HPL, or any other flat sheet building materials. The surface can now have the final carving into the surface and into the filler material below the skin FIG. 5.

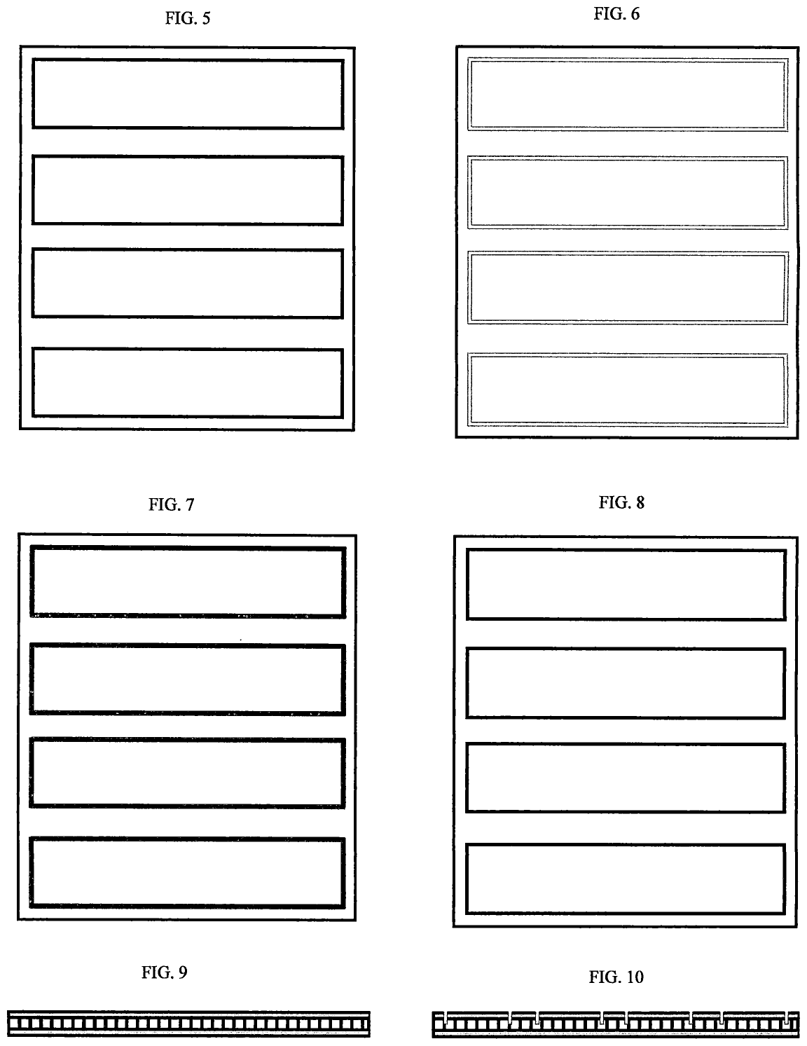

Alternatively, the method can begin as complete hollow core materials with the skins already applied. The initial carving can be cut through the skin material, exposing the core material FIG. 6. The initial carvings can then be filled with a filler material FIG. 7. Filler material can be wood, metals, plastic, fiberglass, epoxy, wood filler compound, metal filler compound, or any combination of the desired fillers. Once the filler material is fully cured, the final carving can be cut FIG. 8. It is important for the grooves to only go partially into the core material as to not create a weak point in the panel FIG. 9 FIG. 10.

What is claimed is:

1. The method of carving hollow core materials can be applied to any hollow core building material, such as panels, beams, posts, doors, tables, or any other hollow core materials. This method can be used with any hollow core material such as paper core, foam core, fiberglass core, honeycomb core such as Sing Core U.S. Pat. No. 7,147,741, or any other hollow core material. The core can be carved in the desired design before the skin of the panel is applied. The channels can then be filled with a filler material such as wood matching the surface material, different wood species, metals, wood filler compound, epoxy, fiberglass, resin, or any other desired filler material. Skin material can then be applied to the panel with an adhesive of choice. Skin material can be any flat sheet building materials such as plywood, sheet metals, HPL, FRP, MDF, or any other flat sheet building materials. The final carving can then be carved out of the surface and into the filler material beneath the skin material.

2. In accordance with claim 1, a finished hollow core panel can be carved through the surface, exposing the core material underneath. The carved channels can be filled with a filler material of choice, same species wood, different species wood, metals, fiberglass, wood filler compound, resin, epoxy, or any combination of filler materials. Once the filler material is fully cured, the final carving can be cut into the filler material.

3. In accordance with claim 1, additional layers of skin material can be adhered to the surface of the panel to be carved, creating a raised design.

4. In accordance with claim 1, raised designs can be applied in combination to carving into or through the base skin using any of the methods described above.
